(19) United States
(12) Patent Application Publication
(10) Pub. No.: US 2016/0237665 A1
(43) Pub. Date: Aug. 18, 2016

(54) PLUG PRECLUDING HOSE ATTACHMENT TO A GARBAGE DISPOSAL

(71) Applicant: Electrolux Home Products, Inc., Charlotte, NC (US)

(72) Inventors: David J. Coll, Charlotte, NC (US); Ralph A. Porcaro, II, Clayton, NC (US)

(21) Appl. No.: 14/620,648

(22) Filed: Feb. 12, 2015

(51) Int. Cl. E03C 1/266; F16K 5/04; B02C 18/22

(52) U.S. Cl. CPC E03C 1/2665; B02C 18/2291; F16K 5/0492

(57) ABSTRACT

Provided herein is a plug that is configured to obstruct an auxiliary inlet of a garbage disposal, and more particularly, to a manually removable plug for an auxiliary inlet of a garbage disposal that precludes attachment of a drain hose from a dishwasher to the auxiliary inlet without removal of the plug. Embodiments may include a garbage disposal including a grinding chamber with a primary inlet and an auxiliary inlet. Embodiments may include a plug for obstructing the auxiliary inlet of a garbage disposal. The plug may include a plug body, a stem, and a handle, where the stem extends between the plug body and the handle. The plug body may define a cylindrical shape having a diameter axially aligned with an axis of the stem. The handle may define a first edge, second edge, and a length defined there between extending perpendicularly to the axis of the stem.

### TECHNOLOGICAL FIELD

Embodiments of the present invention relate to a removable plug for an auxiliary inlet, and more particularly, to a manually removable plug for an auxiliary inlet of a garbage disposal that precludes the attachment of a drain hose from a dishwasher to the auxiliary inlet until the plug is removed.

### BACKGROUND

Household plumbing is an important and critical feature of daily life. Supply-side plumbing provides the water necessary for various appliances in a building, while the return-side plumbing expels wastewater to a sewer or septic system. Appliances such as dishwashers, washing machines, and the like, require a supply of water to properly function. Similarly, each of these appliances requires a water outlet to expel water from the appliance. While water outlets from a water heater remain on the supply-side of household plumbing fixtures and other appliances, washing machines and dishwashers expel water to return-side plumbing. While washing machines expel water to a drain that connects with a household return or sewer line, dishwashers may expel water to a location generally under a sink proximate the dishwasher. Some dishwasher drain lines are connected directly to a downspout from a sink drain. Other dishwasher drain lines are connected to a garbage disposal to help reduce the debris which may be expelled from the dishwasher drain.

### BRIEF SUMMARY

Various embodiments of the present invention are directed to a plug that is configured to obstruct an auxiliary inlet of a garbage disposal, and more particularly, to a manually removable plug for an auxiliary inlet of a garbage disposal that precludes attachment of a drain hose from a dishwasher to the auxiliary inlet without prior removal of the plug.

Embodiments of the present invention may include a garbage disposal including a grinding chamber with a primary inlet and an auxiliary inlet, and a lower portion disposed below the grinding chamber and including a waste outlet. Embodiments may include a motor disposed below the lower portion, where the grinding chamber and lower portion are defined about a central axis, where the primary inlet is arranged along the central axis, and the motor is configured to rotate a grinder within the grinding chamber about the central axis. Example embodiments may include a plug with a plug body, a stem, and a handle. The stem includes an elongate shape with a first end and a second end, with the first end being attached to the plug body and the second end being attached to the handle. The plug body defines a cylindrical shape having a diameter axially aligned with a longitudinal axis of the stem. The handle may define a first edge and a second edge, with a length defined therebetween, the length extending in a direction perpendicular to the longitudinal axis of the stem. The length of the handle may be greater than the diameter of the plug body such that the first edge is positioned outwardly of the diameter of the plug body and the second edge is positioned outwardly of the diameter of the plug body to obstruct and preclude engagement of a drain hose of a dishwasher with the auxiliary inlet.

According to some embodiments, the auxiliary inlet may define an inner diameter, where the plug is configured to engage the auxiliary inlet against the inner diameter. The plug may include a tapered leading edge configured to be received within the inner diameter of the auxiliary inlet. The stem may extend from the plug body along an axis defined through a center of the inner diameter of the auxiliary inlet. The plug body may define a cylindrical cavity aligned with the cylindrical shape of the plug body, where the cylindrical cavity is configured to receive therein the auxiliary inlet of the garbage disposal. The diameter of the plug body may be greater than an inner diameter of the auxiliary inlet where the plug body is configured to form an interference fit with the external diameter of the auxiliary inlet.

According to some embodiments, the plug body may define a cavity having an inner diameter while the cylindrical shape of the plug body defines an outer diameter. The auxiliary inlet may define either an external diameter of a first size or an internal diameter of a second size. The inner diameter of the cavity may be sized such that the plug body engages and seals the external diameter of the auxiliary inlet of the first size, and the outer diameter of the plug body may be sized such that the plug engages and seals the internal diameter of the auxiliary inlet of the second size. The stem of example embodiments may include a cross-shaped cross-section.

Embodiments of the present invention may include a plug for obstructing an auxiliary inlet of a garbage disposal. The plug may include a plug body, a stem, and a handle, where the stem extends between the plug body and the handle. The plug body may define a cylindrical shape having a diameter axially aligned with a longitudinal axis of the stem. The handle may define a first edge, a second edge, and a length defined therebetween extending in a direction perpendicular to the longitudinal axis of the stem. The length of the handle may be greater than the diameter of the plug body such that the first edge is positioned outwardly of the diameter of the plug body and the second edge is positioned outwardly of the diameter of the plug body to obstruct and preclude engagement of a drain hose of a dishwasher with the auxiliary inlet.

According to some embodiments, the plug body may define a cavity having an inner diameter while the cylindrical shape of the plug body defines an outer diameter. The auxiliary inlet may define either an external diameter of a first size or an internal diameter of a second size. The inner diameter of the cavity may be sized such that the plug body engages and seals the external diameter of the auxiliary inlet of the first size, and the outer diameter of the plug body may be sized such that the plug engages and seals the internal diameter of the auxiliary inlet of the second size. The stem of example embodiments may include a cross-shaped cross-section.

Embodiments of the present invention may include a method of manufacturing a garbage disposal. Embodiments may include providing a garbage disposal including a grinding chamber with a primary inlet and an auxiliary inlet, a lower portion of the grinding chamber comprising a waste outlet, and a motor disposed below the lower portion of the grinding chamber. The grinding chamber and lower portion of the grinding chamber are defined about a central axis, where the primary inlet is arranged along the central axis and the motor is configured to rotate a grinder within the grinding chamber about the central axis. Methods of example embodiments may include attaching a plug to the auxiliary inlet, where the plug includes a plug body, a handle, and a stem attaching the plug body to the handle. The plug body may define a cylindrical shape having a diameter axially aligned with a longitudinal axis of the stem, where the handle defines a first edge, a second edge, and a length therebetween extending along a direction perpendicular to the longitudinal axis of the stem. The length of the handle may be greater than the diameter of the plug such that the first edge is positioned outwardly of the diameter of the plug body and the second edge is positioned outwardly of the diameter of the plug body to obstruct and preclude engagement of a drain hose of a dishwasher with the auxiliary inlet.

According to some embodiments, the plug body may define a cavity having an inner diameter while the cylindrical shape of the plug body defines an outer diameter. The auxiliary inlet may define either an external diameter of a first size or an internal diameter of a second size. The inner diameter of the cavity may be sized such that the plug body engages and seals the external diameter of the auxiliary inlet of the first size, and the outer diameter of the plug body may be sized such that the plug engages and seals the internal diameter of the auxiliary inlet of the second size. The stem may include a cross-shaped cross-section.

### BRIEF DESCRIPTION OF SEVERAL VIEWS OF THE DRAWING(S)

Reference will now be made to the accompanying drawings, which are not necessarily drawn to scale, and wherein:

FIG. 1 illustrates a cross-section view of an example garbage disposal that may benefit from example embodiments of the present invention;

FIG. 2 illustrates a plug for an auxiliary inlet of a garbage disposal according to example embodiments of the present invention;

FIG. 3 illustrates a plug engaged around an external diameter of an auxiliary inlet according to example embodiments of the present invention;

FIG. 4 illustrates a plug engaged within the internal diameter of an auxiliary inlet according to example embodiments of the present invention;

FIG. 5 illustrates another view of the plug shown in FIG. 2 according to example embodiments of the present invention; and

FIG. 6 illustrates a garbage disposal including a plug obstructing the auxiliary inlet according to example embodiments of the present invention.

### DETAILED DESCRIPTION

The present invention will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. The terms top, bottom, side, up, down, upwards, downwards, vertical, horizontal, and the like as used below do not imply a required limitation in all embodiments of the present invention but rather are used herein to help describe relative direction or orientation in the example embodiments illustrated in the figures.

Various embodiments of the present invention provide a plug for an auxiliary inlet of a garbage disposal that is configured to preclude connection of a dishwasher drain hose before removal of the plug from the auxiliary inlet.

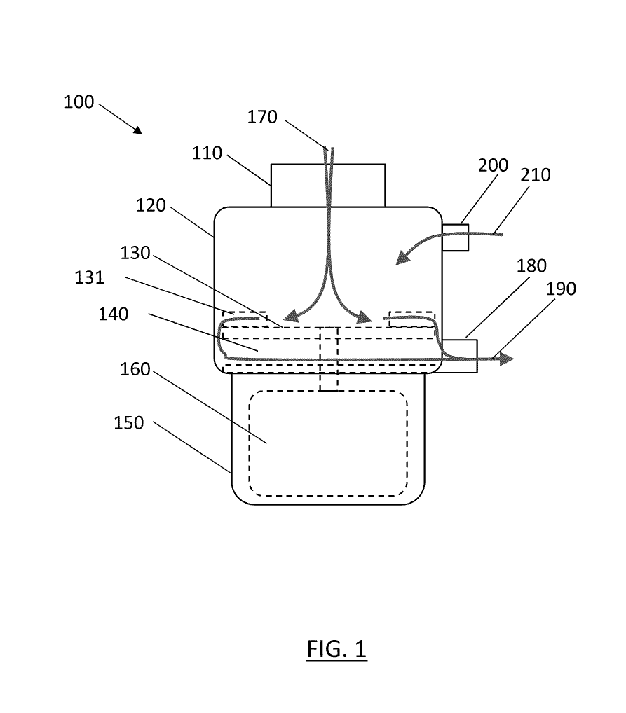

Garbage disposals are generally configured to receive liquids, food and organic matter through the drain of a sink. Garbage disposals grind the food and organic matter to eliminate large pieces that may block a drain pipe or become lodged in a drain pipe, and send the liquid together with the ground food and organic matter to a drain that may lead to a sewer, septic tank, or the like. FIG. 1 illustrates an example of a basic garbage disposal 100 including a collar 110 which may function to secure the garbage disposal 100 to the drain of a sink (not shown). Below the collar 110 is a grinding chamber 120 where the food and organic matter is ground or masticated by a grinding mechanism 130. The grinding mechanism may take many forms and is herein illustrated as merely a plate with grinding teeth 131 attached thereto; however, embodiments of the present invention may be implemented with garbage disposals regardless of their grinding mechanism. The illustrated garbage disposal further includes a lower portion 140, disposed below the grinding mechanism 130, and configured to receive the liquid and the food and organic matter after it has been ground by the grinding mechanism. FIG. 1 further depicts a motor housing 150 including a motor 160 disposed therein, wherein the motor 160 is configured to drive the grinding mechanism 130.

In operation, liquid, food, and organic matter enters the garbage disposal (e.g., along the path identified by arrows 170 in FIG. 1). The food and organic matter is then ground by the grinding mechanism 130, and flows to the lower portion 140, where the liquid and small remnants of the food and organic matter flow through waste outlet 180 (e.g., along arrow 190).

While garbage disposals are generally designed to receive food and organic matter through the inlet at the collar 110, many garbage disposals may include an auxiliary inlet 200 through which food and organic matter may be received (e.g., along arrow 210). For example, a dishwasher may be located proximate a sink including a garbage disposal. While some dishwashers include a built-in garbage disposal or macerating device (e.g., an impeller), other dishwashers may not. In either case, a user or installer may wish to plumb the drain hose of the dishwasher to an auxiliary inlet of a garbage disposal to provide a first, or possibly second level of grinding of any food or organic matter which may be drained from the dishwasher. In such embodiments, a dishwasher may drain water and food or organic matter to the garbage disposal 100 through the auxiliary inlet 200. The water may drain through the lower chamber 140 without the garbage disposal grinding mechanism 130 operating, and a user may later operate the disposal to macerate any food or organic matter that remains from the operation of the dishwasher. That remaining material may then flow along the path identified by arrows 190 through the garbage disposal 100.

As noted above, the use of an auxiliary inlet 200 may be optional for installations that include a dishwasher proximate a sink comprising with an attached garbage disposal 100. In other cases, the garbage disposal 100 may not be located near a dishwasher, such as in kitchens that lack a dishwasher. In such embodiments, it is desirable to plug or stop the auxiliary inlet to preclude water and other material from flowing out of the auxiliary inlet, particularly when the disposal or drain becomes backed up and the grinding chamber fills with liquid and other material. In such cases it is desirable to have a stop or plug obstructing the auxiliary inlet.

Conventionally, a plug of an auxiliary inlet is molded into the auxiliary inlet with a weakened area around the plug to enable an installer or plumber to knock-out the auxiliary inlet plug when the auxiliary inlet is to be used. As such, when a drain hose of a dishwasher is plumbed to the auxiliary inlet, the auxiliary inlet plug may first be removed. However, with the auxiliary inlet plug disposed within the auxiliary inlet, it may be difficult to see and an installer or plumber may neglect or forget to remove the auxiliary inlet plug. Such an oversight may lead to a dishwasher failing to properly drain and causing the dishwasher to flood. Alternatively, the water pressure in the drain hose may force the drain hose from the auxiliary inlet, and the drain hose may release water and material from the dishwasher to the general area where the disposal is installed.

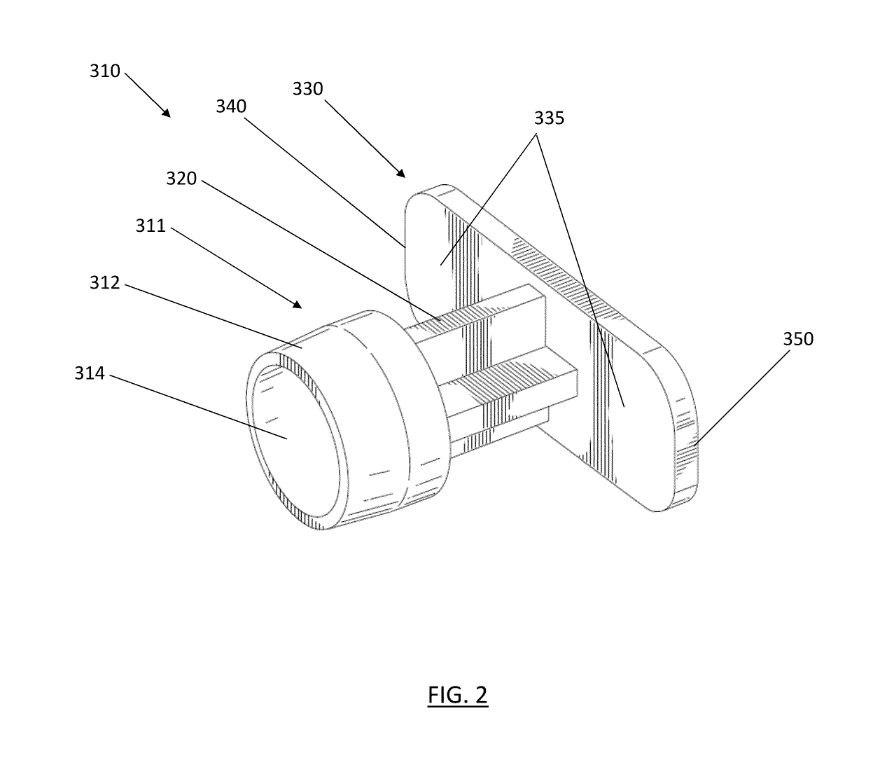

Embodiments of the present invention provide a mechanism to preclude installation of a drain hose to an auxiliary inlet 200 of a garbage disposal 100 while the auxiliary inlet plug is in place. FIG. 2 illustrates an example embodiment of the present invention that includes a plug 310 defining a plug body 311, a stem 320, and a handle 330. The plug may be configured to obstruct the auxiliary inlet of the garbage disposal 100. The plug 310 may be configured to be received inside the inner diameter of the auxiliary inlet 310 such that the outside diameter of the plug 310 may be the same as the diameter of the auxiliary inlet, or sized such that there is an interference fit between the plug 310 outer diameter and the auxiliary inlet inner diameter. In some embodiments, the plug may be made from a somewhat flexible material, such as a ductile rubber or plastic, as described further below. The ductility of the plug 310 may enable the plug to be pressed into the inner diameter of the auxiliary inlet 200 and form a seal with the inner diameter of the auxiliary inlet.

According to some embodiments, the plug 310 may define a plug body 311 that defines a tapered leading edge 312 which may facilitate installation of the plug 310 into the auxiliary inlet 200, and aid in creating a seal between the plug and the auxiliary inlet. Example embodiments may also include a cavity 314 within the plug body 311. The cavity may, for example be a cylindrically shaped cavity. The cavity may aid in installation of the plug 310 within the auxiliary inlet 200 by enabling deformation of the leading edge of the plug as it is inserted into the auxiliary inlet.

While the example embodiment of FIG. 2 is described as a plug that is configured to be received inside the inner diameter of the auxiliary inlet 200, embodiments may optionally be configured to engage the auxiliary inlet 200 by fitting around the external diameter of the auxiliary inlet. For example, the cavity 314, as shown in FIG. 2, may be configured to be a cylindrical cavity, and may have diameter that enables an interference fit with the outer diameter of the auxiliary inlet 200. The diameter of the cylindrical cavity may be smaller than the external diameter of the auxiliary inlet, and the plug may be made of a ductile material to enable the cavity to be expanded around and to form a seal with the external diameter of the auxiliary inlet.

According to some embodiments, the plug 310 may be configured to engage and obstruct auxiliary inlets of two different sizes. For example, a plug 310 may be sized such that the outer diameter of the plug is sized to engage the inner diameter of a ¾-inch inside-diameter auxiliary inlet 200. The cavity 314 of the same plug 310 may be sized to engage the outside diameter of a ½-inch inside-diameter auxiliary inlet 200. Thus, the same plug could be used for a ¾-inch inside-diameter auxiliary inlet and a ½-inch inside-diameter auxiliary inlet, thereby reducing part complexity in manufacture.

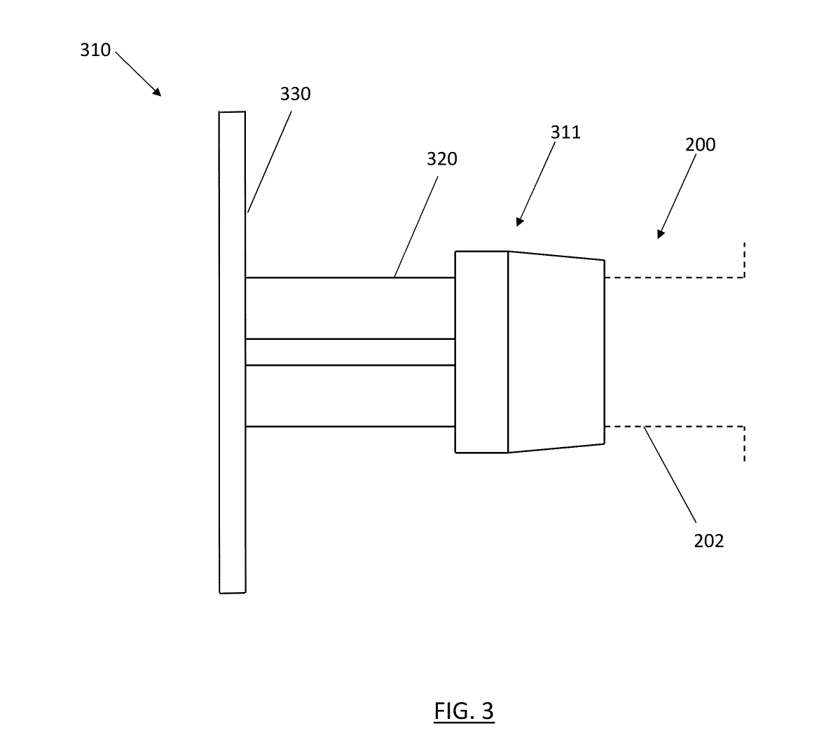

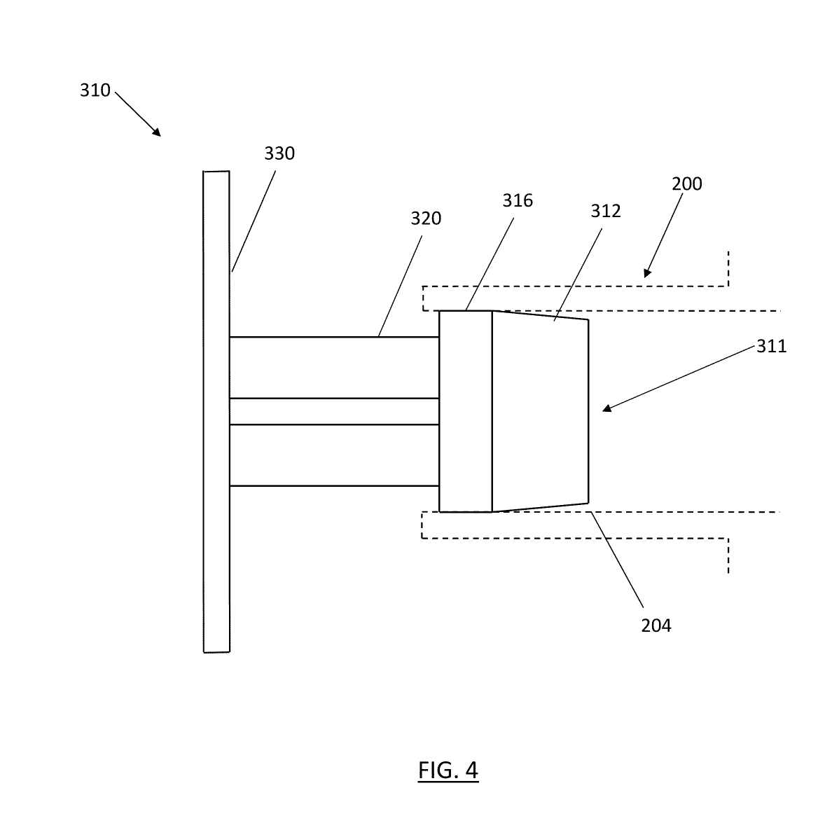

FIG. 3 illustrates an example embodiment in which the cavity 314 of a plug 310 is configured to engage the external diameter 202 of an auxiliary inlet 200. As shown, the plug 310 may seal the auxiliary inlet 200, such as by elastically expanding around the external diameter 202 of the auxiliary inlet. FIG. 4 illustrates an example embodiment in which the outer diameter 316 of the plug 310 is configured to engage and seal the inner diameter 204 of an auxiliary inlet 200. As shown, the tapered leading edge 312 may facilitate insertion of the plug 310 into the inner diameter 204 of the auxiliary inlet.

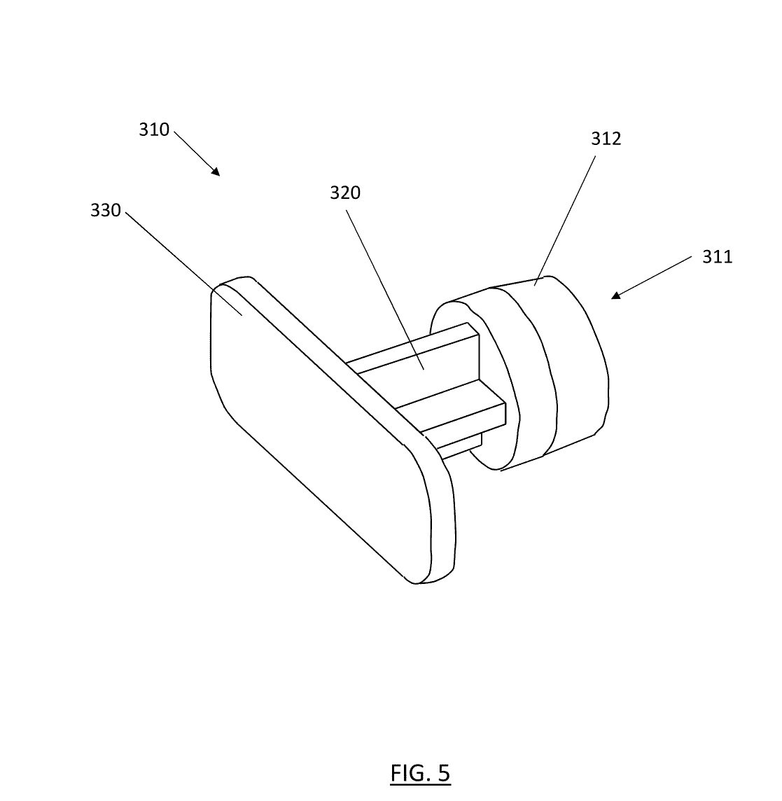

As noted above, the plug 310 includes a stem 320 extending therefrom and a handle 330. The stem 320 may be configured, as shown in FIGS. 2 and 5, with a cross-shaped cross-section. This may enable a secure attachment between the handle 330 and the plug 310. Such a cross section may also limit the flexibility of the stem 320 while providing the strength necessary to enable a user to remove the plug 310 from the auxiliary inlet 200 by pulling on the handle 300. The non-cylindrical shape may further facilitate removal of the plug 310 from an auxiliary inlet with the use of a tool, such as a pair of slip-joint or channel-lock pliers. The non-cylindrical shape may enable a twisting motion to be imparted to the plug via the stem 320 using such a tool. Optionally, the stem may be of a variety of shapes and cross-sections that would provide a secure attachment between the handle 330 and the plug body 311. While a non-cylindrical cross-section may facilitate tool-based removal, a cylindrically shaped stem may also be used.

The handle 330 may define a first edge 340 and a second edge 350 with a length defined there between. The length between the first edge 340 and the second edge 350 may be selected to be larger than that of an inner diameter of a hose that is to connect to the auxiliary inlet such that such a hose cannot be connected to the auxiliary inlet without first removing the plug 310. The handle 330 may be shaped to facilitate the pulling motion of a plug axially away from the auxiliary inlet. For example, the major surfaces 335 of the handle 330 may be arranged to be orthogonal to the axis of removal of the plug 310 to provide a user a larger surface over which pressure from a user's fingers may be distributed. This may enable a user to more comfortably apply a larger pulling force against the major surfaces 330 to remove the plug 310 from the auxiliary inlet. The cross-shaped cross-section of stem 320 may help resist folding of the handle 330 as it is pulled by a user as the width of the cross-section, in the direction of the major surfaces 335, may help to keep the handle 330 flat.

Example embodiments may include a handle 330 that is integrally formed with the stem 320 and the plug body 311; however, additional embodiments may include a handle that can be formed separately from the plug 310 and attached to the plug body or the stem. Further, while embodiments are described herein to have a handle that precludes attachment of a drain hose of a dishwasher to an auxiliary inlet of a garbage disposal, embodiments may include a cross-piece that serves the same function, while the handle is formed separately from the cross-piece.

FIG. 5 provides a different perspective view of the plug of FIG. 2 illustrating the cross-shaped cross-section of the stem 320 as it is attached to the plug body 311. The surface area of attachment between the plug body 311 and the stem 320 may facilitate greater strength between the stem and the plug body to reduce the likelihood of the plug and stem becoming separated as a user pulls the handle 330 to remove the plug body from the auxiliary inlet 200.

A plug according to example embodiments of the present invention may be made from a variety of materials. Materials such as polyvinyl chloride (PVC), polypropylene (PP), high- or low-density polyethylene (HDPE/LDPE), natural or synthetic rubber, etc. These materials may include some level of ductility that may enable them to provide a seal to close the auxiliary inlet. The plug, stem, and handle, may be injection molded or thermoformed as a single piece, or alternatively the plug may be assembled from separate pieces, such as extruded or injection molded stems, handles, and plug bodies that are ultrasonically welded or otherwise adhered to one another.

While the illustrated embodiment of a plug and the above general description of attachment of the plug 310 to an auxiliary inlet 200 is accomplished with an interference fit or frictional engagement, plugs of example embodiments may be attached to an auxiliary inlet through a variety of methods. For example, the plug may be threaded, either with an external thread or an internal thread, and the auxiliary inlet may be configured with an external thread (for receiving an internal thread of the plug) or an internal thread (for receiving an external thread of the plug). Further, the auxiliary inlet may be configured with one or more barbed ribs as found on a tubing nipple for engaging an internal diameter of a plug. The plug of example embodiments may optionally be attached using a hose clamp, zip tie, or the like to provide additional security to the connection. The auxiliary inlet and plug may be configured for a quick-connect/quick-disconnect feature such as a detent or snap fit. The plug may optionally be integrally molded with the auxiliary inlet and configured with a region of stress concentration around the plug to enable the plug to break-away with the application of sufficient force to the plug. The plug may be temporarily attached to the auxiliary inlet with the use of a non-permanent adhesive such as a glue or ultrasonic weld. Regardless of the attachment method between the plug and the auxiliary inlet, in some embodiments, the plug is configured to remain engaged with the auxiliary inlet during transport of the garbage disposal, installation, and use of the garbage disposal. In this regard, the plug is configured to be removable only by deliberate force or action to remove the plug.

According to example embodiments in which the plug is integrally formed with the auxiliary inlet with a break-away region, or where the plug is attached/adhered to the auxiliary inlet by a bond, seal, or adhesive that requires breaking prior to removal of the plug, the handle of example embodiments may provide a strike surface. The strike surface may be configured to receive a force, such as from a hammer, mallet, wrench, or the like, to break the seal, adhesive, or bond between the plug and the auxiliary inlet. Once the seal, adhesive, or bond is broken, the handle may be used to remove the plug from the auxiliary inlet.

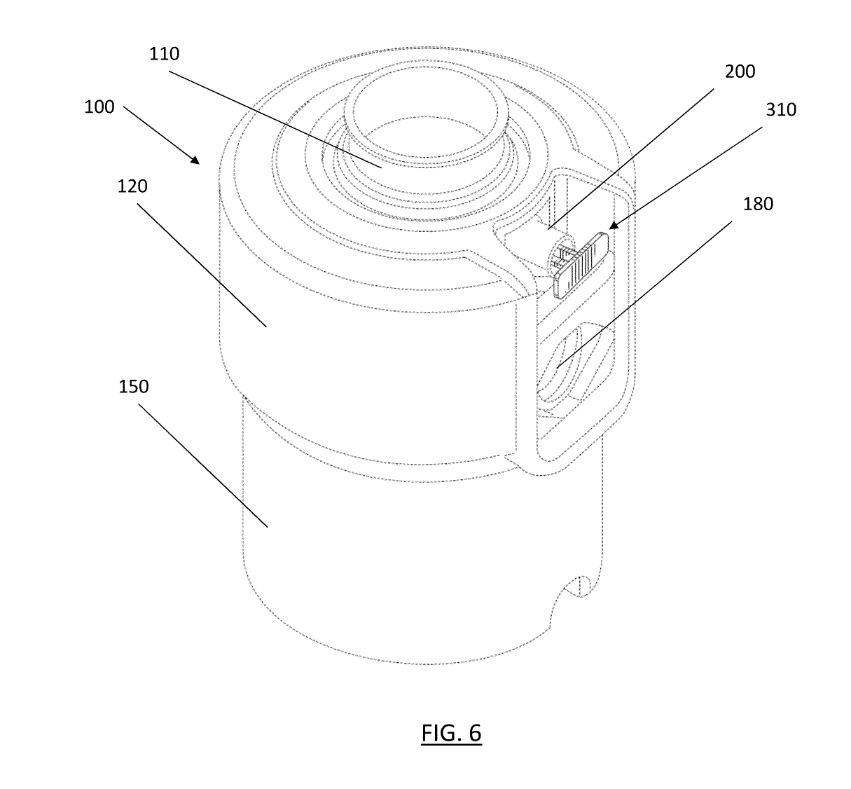

FIG. 6 illustrates a perspective view of a garbage disposal 100 with an auxiliary inlet 200 that is obstructed by a plug. The handle 330 of the plug can be seen with the stem 320 extending into the inner diameter of the auxiliary inlet 200. As shown, the garbage disposal 100 can be installed in a location without a connection to the auxiliary inlet 200. Should the garbage disposal 100 be installed in a location where the auxiliary inlet is needed for attachment of a dishwasher drain hose, the plug may be removed. A user cannot attach the drain hose without removing the plug as the handle 330 blocks access to the auxiliary inlet until the plug is removed. As such, a dishwasher drain hose cannot be attached to the auxiliary inlet without first removing the plug, thereby preventing a potential condition where a drain hose is attached to a blocked auxiliary inlet.

The auxiliary inlet may be sized to receive a dishwasher drain hose either around an outer diameter of the auxiliary inlet, or alternatively, the internal diameter of the auxiliary inlet may be sized to receive a drain hose from a dishwasher therein. In either case, the dishwasher drain hose and the auxiliary inlet are sized to engage one another in such a manner as to create a seal, thereby minimizing the opportunity for leaks to develop between the drain hose and the auxiliary inlet. In an embodiment in which the drain hose receives the auxiliary inlet within an inner diameter of the drain hose, a hose clamp may be employed to secure and seal the hose on the auxiliary inlet. The handle of the plug and more particularly, the length of the plug handle defined between the first edge 340 and the second edge 350 may be sized to ensure that a dishwasher drain hose cannot be received over the handle 330 of the plug. This prevents connection of the drain hose to the auxiliary inlet while the plug is engaged with the auxiliary inlet thereby preventing improper attachment and causing proper draining from the dishwasher.

While embodiments of the present invention have been herein described with regard to a garbage disposal and a plug for an auxiliary inlet for a garbage disposal, embodiments of the present invention may further include a method of manufacturing a garbage disposal and/or a plug for an auxiliary inlet of a garbage disposal, such as attaching a plug as described herein to an auxiliary inlet of a garbage disposal.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A garbage disposal comprising:
a grinding chamber comprising a primary inlet and an auxiliary inlet;
a lower portion disposed below the grinding chamber comprising a waste outlet;
a motor disposed below the lower portion, wherein the grinding chamber and lower portion are defined about a central axis, wherein the primary inlet is arranged along the central axis, and wherein the motor is configured to rotate a grinder within the grinding chamber about the central axis; and
a plug obstructing the auxiliary inlet, wherein the plug comprises:
a plug body;
a stem comprising an elongate shape with a first end and a second end, the first end attached to the plug body; and
a handle attached to the second end of the stem, wherein the plug body defines a cylindrical shape having a diameter axially aligned with a longitudinal axis of the stem, wherein the handle defines a first edge, a second edge, and a length therebetween, wherein the length extends in a direction perpendicular to the longitudinal axis of the stem, wherein the length of the handle is greater than an inner diameter of a drain hose of a dishwasher configured for attachment to the auxiliary inlet.

2. The garbage disposal of claim 1, wherein the auxiliary inlet defines an inner diameter, wherein the plug is configured to engage the auxiliary inlet against the inner diameter.

3. The garbage disposal of claim 2, wherein the plug comprises a tapered leading edge configured to be received within the inner diameter of the auxiliary inlet.

4. The garbage disposal of claim 2, wherein the stem extends from the plug body along an axis defined through a center of the inner diameter of the auxiliary inlet.

5. The garbage disposal of claim 1, wherein the plug body defines a cylindrical cavity axially aligned with the cylindrical shape of the plug body, and wherein cylindrical cavity is configured to receive therein the auxiliary inlet of the garbage disposal.

6. The garbage disposal of claim 5, wherein a diameter of the plug body is greater than an inner diameter of the auxiliary inlet, and wherein the plug body is configured to form an interference fit with the external diameter of the auxiliary input.

7. The garbage disposal of claim 1, wherein the plug body defines a cavity having an inner diameter, and the cylindrical shape of the plug body defines an outer diameter, wherein the auxiliary inlet defines either an external diameter of a first size or an internal diameter of a second size, wherein the inner diameter of the cavity is sized such that the plug body engages and seals the external diameter of the auxiliary inlet of the first size, and wherein the outer diameter of the plug body is sized such that the plug engages and seals the internal diameter of the auxiliary inlet of the second size.

8. The garbage disposal of claim 1, wherein the stem comprises a cross-shaped cross-section.

9. The garbage disposal of claim 1, wherein the first edge of the handle is positioned outwardly of the diameter of the plug body and the second edge of the handle is positioned outwardly of the diameter of the plug body to obstruct and preclude engagement of a drain hose of a dishwasher with the auxiliary inlet.

10. A plug for obstructing an auxiliary inlet of a garbage disposal, comprising:
a plug body;
a stem comprising an elongate shape with a first end and a second end, the first end attached to the plug body; and
a handle attached to the second end of the stem, wherein the plug body defines a cylindrical shape having a diameter axially aligned with a longitudinal axis of the stem, wherein the handle defines a first edge, a second edge, and a length therebetween, wherein the length extends in a direction perpendicular to the longitudinal axis of the stem, wherein the length of the handle is greater than an inner diameter of a drain hose of a dishwasher configured for attachment to the auxiliary inlet.

11. The plug of claim 10, wherein the plug body defines a cylindrical cavity axially aligned with the cylindrical shape of the plug body, and wherein the cylindrical cavity is configured to receive therein the auxiliary inlet of the garbage disposal.

12. The plug of claim 11, wherein a diameter of the plug body is greater than an inner diameter of the auxiliary inlet, and wherein the plug body is configured to form an interference fit with the internal diameter of the auxiliary inlet.

13. The plug of claim 10, wherein the plug body defines a cavity having an inner diameter, and the cylindrical shape of the plug body defines an outer diameter, wherein the auxiliary inlet defines either an external diameter of a first size or an internal diameter of a second size, wherein the inner diameter of the cavity is sized such that the plug body engages and seals the external diameter of the auxiliary inlet of the first size, and wherein the outer diameter of the plug body is sized such that the plug engages and seals the internal diameter of the auxiliary inlet of the second size.

14. The plug of claim 10, wherein the stem comprises a cross-shaped cross-section.

15. The plug of claim 10, wherein the first edge of the handle is positioned outwardly of the diameter of the plug body and the second edge of the handle is positioned outwardly of the diameter of the plug body to obstruct and preclude engagement of a drain hose of a dishwasher with the auxiliary inlet.

16. A method of manufacturing a garbage disposal comprising:
providing a garbage disposal comprising:
a grinding chamber comprising a primary inlet and an auxiliary inlet;
a lower portion comprising a waste outlet; and
a motor disposed below the lower portion, wherein the grinding chamber and lower portion are defined about a central axis, wherein the primary inlet is arranged along the central axis, and wherein the motor is configured to rotate a grinder within the grinding chamber about the central axis; and attaching a plug to the auxiliary inlet, wherein the plug comprises:
a plug body;
a stem comprising an elongate shape with a first end and a second end, the first end attached to the plug body; and
a handle attached to the second end of the stem, wherein the plug body defines a cylindrical shape having a diameter axially aligned with a longitudinal axis of the stem, wherein the handle defines a first edge, a second edge, and a length therebetween, wherein the length extends in a direction perpendicular to the longitudinal axis of the stem, wherein the length of the handle is greater than an inner diameter of a drain hose of a dishwasher configured for attachment to the auxiliary inlet.

17. The method of claim 16, wherein the plug body defines a cylindrical cavity axially aligned with the cylindrical shape of the plug body, and wherein cylindrical cavity is configured to receive therein the auxiliary inlet of the garbage disposal.

18. The method of claim 17, wherein a diameter of the plug body is greater than an inner diameter of the auxiliary inlet, and wherein the plug body is configured to form an interference fit with the internal diameter of the auxiliary inlet.

19. The method of claim 16, wherein the plug body defines a cavity having an inner diameter, and the cylindrical shape of the plug body defines an outer diameter, wherein the auxiliary inlet defines either an external diameter of a first size or an internal diameter of a second size, wherein the inner diameter of the cavity is sized such that the plug body engages and seals the external diameter of the auxiliary inlet of the first size, and wherein the outer diameter of the plug body is sized such that the plug engages and seals the internal diameter of the auxiliary inlet of the second size.

20. The method of claim 16, wherein the stem comprises a cross-shaped cross-section.
